(19) United States
(12) Patent Application Publication
(10) Pub. No.: US 2009/0152808 A1
(43) Pub. Date: Jun. 18, 2009

(54) DRIVE CYLINDER WITH MOVABLE GRAB

(76) Inventor: Rainer WIELAND, Wuerzburg (DE)

Correspondence Address: K.F. ROSS P.C., 5683 RIVERDALE AVENUE, SUITE 203 BOX 900, BRONX, NY, 10471-0900, US

(21) Appl. No.: 12/331,714

(22) Filed: Dec. 10, 2008

(30) Foreign Application Priority Data
Dec. 18, 2007 (DE) 102007061556.8

(51) Int. Cl. B65H 5/12; B41F 13/08

(52) U.S. Cl. 271/275; 270/19

(57) ABSTRACT

Sheets are conveyed through a printing or coating machine having at least one gripping assembly for gripping and holding a leading edge of a sheet to be transported and lying in at least one recess of the cylindrical transport drum and rotating with the cylindrical transport drum about its rotation axis. This grab and the respective support of the gripping assembly are moved by a drive provided in or on the cylindrical transport drum during a predetermined or predeterminable angular travel of the cylindrical transport drum along a straight path tangentially to an outer surface of the cylindrical transport drum.

The invention relates to a cylindrical transport drum for conveying sheets in a printer or coater and having at least one grab that grips and securely holds the leading edge of a sheet to be conveyed and that is mounted in at least one recess of the transport drum to rotate with the transport drum about its rotation axis. The invention furthermore relates to a method of conveying sheets in a printer or coater, where the leading edge of a sheet to be conveyed is gripped and securely held using at least one grab that is provided in at least one recess of a transport drum and that rotates with the transport drum about its rotation axis.

Printers and coaters for printing or coating sheet print substrates have been used commercially for many years. Since the subject matter of the invention can be employed both in printers and in coaters, all of the following descriptions relate both to printers and coaters with no restriction in terms of universality.

One type of such a printer works using the principle of rotary printing, such as for instance flexoprinting, offset printing, letterpress printing, gravure printing, etc., in which the image to be printed is applied to a surface of one or a plurality of print cylinders or is fixed onto the surface of an impression cylinder as a printing plate and during the print process the print image is transferred to the print substrate either directly or via downstream transfer cylinders by rolling on the surface of the impression cylinder. To this end the print image on the impression cylinder is inked by one or even a plurality of inking rollers such that with each rotation of the impression cylinder there is uniform inking of the ink-transfer zones of the print image across the entire print impression, which ensures that the print quality on the print substrate is largely constant.

When printing sheets of print substrates, the sheets to be printed are continuously and automatically removed from a supply stack prior to being printed and fed to the printing machine, the sheets then being removed from the printing machine after they have been printed, where necessary the ink that has been applied is then dried, and the sheets are placed on an output stack. In doing this it is necessary to align the sheets prior to their being printed with respect to the printing machine and in particular with respect to the print image, using corresponding reference marks such that all sheets printed form then on are printed uniformly and, in particular in the case of multi-color printing in successive printing machines, each of the colors in the print impression are printed in register on each sheet.

In order to attain this it is necessary to transfer the individual sheets between the individual modules within the printer such that on the one hand there is a continuous and seamless transfer and on the other hand the sheet is aligned or realigned relative to the specific corresponding reference positions so that in particular during multi-color printing a properly registered print impression can be produced.

To this end the sheets to be printed are removed from a supply stack by a first grab, for instance a vacuum grab, and fed to a system apparatus in which the sheets are each aligned against reference edges or against respective stops. Once the sheets have been aligned in this manner, the leading edge of each sheet is gripped by a second grab and for instance drawn onto the surface of a cylinder.

The second grab can advantageously be integrated into the cylinder and rotate with the cylinder about its rotation axis. Gripping fingers of the grab are opened and closed either mechanically via appropriately shaped stationary cams or even electrically or pneumatically via respective actuators and associated control devices. In order to prevent unnecessary further transfer of the sheet, the cylinder is frequently made as a counter-impression cylinder so that the sheet disposed on the surface of the cylinder can be printed on the cylinder. After printing, the sheet must be removed from the counter-impression cylinder, specifically it must be removed such that there is no contact with the printed side of the sheet and no damage to the print impression that has just been printed and is not yet dry.

To this end the sheet is gripped on its leading edge by a third grab, pulled of the cylinder surface of the counter-impression cylinder at largely the same sheet speed, and fed to further stations.

However, in particular when using very stiff and/or thick materials, handling problems arise with the above-described method due to the flexural stresses that occur, and this can lead to problems with reliably transporting such sheets via the cylinders. In this case it makes more sense to transport and print such materials in one straight-line pass through a printer or coater. In this case, it is disadvantageous that the sheet be conveyed unguided via only the printing machine for a brief period, at least when entering and/or exiting the printing machine, which can lead to problems with the print impression.

In particular when coating sheets it is useful to use low-viscosity coating agent in order for the coating agent to attain a good protective effect for an image already printed on the sheet and in order for the layer of coating agent to produce a desired high-gloss surface for the printed sheet. A low-viscosity coating agent clearly has better properties on the sheet surface so that better results can be obtained with it. Moreover, as a rule, significantly thicker layers are applied to the sheet with a coater in order to further increase the protective effect of the coating agent and the gloss of the layer of coating agent.

To this end it is frequently necessary to remove a sheet coated in this manner from a coater without a grab so that there is the risk that, especially in the case of very thin and/or very flexible materials, the sheets remain stuck to the applicator roll due to adhesion forces after the leading edge has been released by the grabs. There is thus the danger that individual sheets will also be taken by the applicator roll and will wind about the applicator roll, which means that the machine must be stopped and the fault must be corrected.

It is therefore desirable to guide the sheets in the region of the nip of a printer or coater, regardless of sheet thickness and regardless of the properties of the inks or coating agent used, such that, in particular given straight travel, the sheets are guided through the nip between the applicator roll and the backing roll in a straight path at least for a predetermined travel, in order in this manner to be transferred by a downstream, known grab and/or transport system.

The object of the invention is therefore to create an apparatus and a method with which a sheet to be printed can be conveyed in a straight line and in a guided manner through the nip of a printer or coater and the sheet can be transferred to a downstream transport system in a guided manner at a predetermined spacing from the nip.

The object is attained in that the grab and its associated support of the grab or grabs are moved tangentially to the surface of the transport drum across a predetermined or predeterminable arcuate portion of the transport drum using an actuator provided in or on the transport drum. Thus the leading edge of the sheet print substrate can be raised tangentially from the surface of the cylindrical transport drum during a predetermined angular movement of the transport drum by the grab and can follow an external straight-line path. In particular, movement tangential to the surface is intended to indicate that the grabs are moved along an imaginary tangent that is fixed to the print machine and that does not also rotate and that coincides with the sheet travel direction.

Thus an inventive transport drum on which a sheet to be printed is clamped in a first step can have a gripping assembly whose the outer ends perform, with respect to an external straight-line transport direction, a movement parallel thereto at least during a predetermined angular travel of the transport drum, and the leading edge of a sheet held by the grab outer ends can thus perform move in a straight line at least during a predetermined angular movement of the transport drum. The angular movement can be adjusted such that the straight-line travel begins in, ends in, or passes through the nip, the nip being determined by the spacing between impression cylinders or application cylinder and transport roller, which can simultaneously also work as an counter-impression cylinder at the same time.

To this end, in accordance with the invention the cylindrical transport drum has in its surface at least one recess extending to its cylinder axis for receiving a gripping assembly.

In this case during one complete rotation of the transport drum about its rotation axis in a predetermined or predeterminable angle range of the rotation the movement path of the grabs and the associated support of the at least one grab describes a straight line that is tangential to the surface of the transport drum and through a predetermined segment along an external straight-line path of the leading edge of the sheet, it being possible to produce the straight-line travel by simultaneous movement of the grabs and their associated support into or out of the respective recess relative to the rotated transport drum and rotation of the grabs and their associated support about the rotation axis of the transport drum. This preferred type of combined movement can result from a controlled change of the spacings between the grabs and supports and the rotation axis of the cylindrical transport drum when it rotates.

Thus the tangential movement of each grab and its associated support of the at least one grab can coincide with the sheet guide direction specified by a printer.

Different ways of performing the method may be desired.

For instance, when the transport drum rotates the leading edge of a sheet gripped with the grabs that has been guided about the cylinder, in particular starting from the nip between transport drum and impression cylinder, is guided tangentially to the outer surface of the transport drum, the at least one grab moving out of the respective recess, whereupon the at least one grab releases the sheet and moves back into the respective recess. During, prior to, or after this release such a sheet can be gripped by a downstream device and guided further.

Likewise, when the transport drum rotates the at least one grab moves out of the respective recess, grips the leading edge of a sheet fed in the straight-line direction, and guides it, tangential to the surface of the transport drum, using the grabs during the further rotation of the cylindrical transport drum, the at least one grab then moving into the respective recess. Such a sheet that has been gripped can then be guided further about the transport drum or during further rotation of the transport drum the at least one grab moves back out of the respective recess, further guides the leading edge of a sheet tangential to the surface of the transport drum and releases it, whereupon the at least one grab moves back into the recess. In this case, as well, such a sheet can be gripped by a downstream device and guided further during, prior to, or after this release.

In particular with the latter manner of performing the method, a sheet can be guided through the nip of a printer in a straight-line sheet guidance direction tangential to the surfaces of the two cylinders.

In this case, it can preferably be provided that the movement by the at least one grab into or out of the respective recess and/or the gripping and release of a sheet is controlled by followers, in particular rollers on the at least one grab, which rollers when the transport drum rotates are guided on nonrotating guides, in particular cam disks.

The functions of the grab can be controlled for instance by at least one fixed cam disk and via respective guides that are attached to the grab and or to the cylindrical transport drum or alternatively even by a different controlled actuator.

Moreover, in accordance with the invention the grab or at least a part of the grab is moveable in the respective recess of the transport drum in the radial direction and/or direction.

Furthermore according to the invention the position and/or the location of the grab in the region of the respective recess of the transports cylinder can be selectively adjusted by overlapping a radial displacement and a tangential displacement and/or a tilting of the grab about a rotation axis that is parallel to the axis of the transport drum.

Furthermore according to the invention the position and/or the location of the grab in the region of the recess of the transport drum can be adjusted using at least one fixed exterior cam.

Furthermore according to the invention the position and the location of the grab or at least a part of the grab in the region of the recess can be below or above the surface or inside or outside the surface diameter of the transport drum.

For receiving the at least one grab, the transport drum has extending across a portion of its surface at least one recess that is formed such that a grab in this recess comes to be in a predetermined position, in particular a position that can be adjusted by external means, below the surface of the cylindrical transport drum, this making it possible for the surface of the transport roller to roll over for instance an impression cylinder positioned on the surface of the transport drum.

The object of the grab in this case is to grip and securely hold by its leading edge a sheet conveyed from a supply device to the transport drum such that the sheet assumes a defined position on the surface of the transport drum at least during a predetermined portion of the angular movement of the transport drum. To this end, the grab has a predetermined number of gripping elements, each of which can be opened or closed in order in this manner to grip or release the leading edge of a sheet to be conveyed. For adjusting the sheet in a predetermined position in the supply direction, each gripping element also has a mechanical stop against which the leading edge of the sheet to be conveyed can be placed by the upstream transport device immediately prior to being fixed by the gripping elements.

To this end, the upstream transport device can have for instance a slightly higher transport speed than the circumferential speed of the transport drum, in particular at least within the transfer zone, so that the leading edge of the sheet is pushed against the stops of the gripping elements and thus the sheet assumes a defined position in the transport direction. It can be useful to design the stops so that their position can be adjusted in order for the position of the sheet on the surface of the cylindrical transport drum to be adjustable.

In one preferred embodiment a grab can include at least one end plate that is arranged on one end of the transport drum and that has at least two first followers, in particular rollers, that are guided in or on two first guides, in particular cam recesses, that rotate with the transport drum, the movement of the grab relative to the transport drum being defined by the first guides. Thus when the transport drum rotates a grab can be moved back and forth along this first guide so that the grab can be moved out of and back into the respective recess.

In addition, an end plate can have at least one second follower, in particular a roller, that is guided on or in a second guide, in particular a cam disk, that does not rotate with the transport drum, the grab being movable or moved into the first guides by the second guide as a function of the angular position between cylindrical transport drum and this second guide. Thus the movement of the grab along the first guide is initiated by guiding the at least one second follower on or in the second guide when the transport drum rotates.

In order to form a gripping mechanism, a pivotal two-armed control lever is carried on an end plate and has one arm that forms a grab or gripping finger that cooperates with a support and another arm that has a third follower, in particular a roller, that is guided on or in a third guide, in particular a cam disk, that does not rotate with the transport drum, the grab being movable or moved relative to the support by the third follower as a function of the angular position between transport drum and this third guide. The control lever can preferably be supported by a spring element, in particular a compression spring on the end plate, this spring element being able to increase the spacing between a second and a third follower.

Such an embodiment can preferably be employed when a second and a third follower, in particular second and third rollers are arranged between the second and third guide cams of the second and third guide disks, the second roller being pressed against the second guide cam and the third roller being pressed against the third guide cam by the spring effect of the spring element.

In one refinement, a grab can have two end plates that are on the ends of the transport drum and that are connected to one another, in particular by a bar that forms the support for all grabs. The control arms that are pivotal on the end plates can be carried on the same rotation axle that is preferably formed by a common rotation shaft that can extend between the end plates.

At least one additional grab can be arranged on the common rotation shaft between the two end plates and all the grabs can be simultaneously movable relative to the support. For synchronous gripping, a stop can be arranged on one grab or one support. Thus the grab can basically include one shaft having gripping elements that are rotatable thereon and that each have sheet stops, each end of the shaft being attached to an end plate. For reasons of stability it can be useful to add additional stiffeners between the end plates.

Thus, with respect to the above-described embodiments, in the embodiment having two end plates, attached to both end faces of a transport drum can be a number of at least two first rollers or first slide elements that engage in respective first guide grooves and that are attached to the cylindrical transport drum so that the grab is movable in the recess of the transport drum along this guide groove. This makes it possible to design the grab to be movable in the recess of the transport drum, so that depending on the shape and configuration of the first guide grooves the grab can be positioned within the recess of the transport drum or can at least be positioned somewhat above the recess delimited by the surface of the transport drum.

Moreover, depending on the embodiment and shape of the first guide grooves or cam recesses, it is possible to change the position of the grab and for instance to rotate it for instance at least about a predetermined angle range. In accordance with the invention, the grab thus does not have a fixed position relative to the transport drum and in particular is not connected thereto via fixed shafts, so that the position of an instantaneous rotation axis of the grab can be changed depending on the position of the grab in the first guide grooves.

For controlling the position of the grab as a function of the angular position of the cylindrical transport drum, it can furthermore be inventively provided that the end plates of the grab each have second rollers or second slide elements that run via the edge of at least one first fixed cam disk, i.e. a cam disk that does not rotate with them, that forms the above-described second guide.

The shape and configuration of the first cam disk or of the second guide in general, which can also be provided by grooves, is selected such that, for the transfer of the sheet from an upstream transport device, in a predetermined portion of the angular travel of the transport drum the grab is raised out above the surface of the transport drum such that the leading edge of the sheet can be placed securely against the stops of the gripping elements and the leading edge of the sheet can be securely gripped by the grabs.

At the same time it is necessary to open the gripping elements so that the leading edge of the sheet can be placed against the stops of the gripping elements and the sheet can then be gripped and securely held by the gripping elements.

In order to open the grabs of the gripping assembly at during a predetermined of the angular travel of the transport drum so that for instance one sheet advanced by an upstream transport device can be gripped and securely held at its leading edge or in order to be able to transfer a printed sheet after it has been printed to a downstream transport device, the end plates of the grab have third rollers or third followers that are rotatably mounted on the end plate via at least one lever arm with the gripping elements and by means of which end plate the gripping elements can be correspondingly opened or closed. To this end the third rollers or third slide elements are guided for instance along the edge of a third guide that is formed as a second cam disk and that is for instance fixed, that is, does not also rotate on the printer.

Naturally other followers such as for instance appropriately shaped guide grooves may also be employed instead of the above-described cam disks.

If the transport drum is now rotated about its longitudinal axis in the working direction, in a first angular segment in which a delivered sheet is to be transferred by the transport drum, the grab is raised far enough above the surface of the transport drum via the first cam disk in its first guide groove and the gripping elements are opened by the second cam disk such that the leading edge of the sheet to be transferred strikes the stops of the gripping elements and the sheet is thus aligned in the transport direction.

Immediately thereafter the gripping elements are closed via the second cam disk during the further rotation of the cylindrical transport drum in the working direction and the leading edge of the sheet is thus gripped and securely clamped by the gripping elements, and during further rotation of the transport drum the sheet is pulled out of the upstream transport device onto the surface of the transport drum. At the same time the grab is moved back into the recess of the transport drum via the first cam disk so that it is possible for instance pressure rollers arranged along the surface to roll over the surface.

Thus, on further rotation of the transport drum in the working direction, the sheet to be printed travels into a nip of an impression roller and leaves it after being printed.

In accordance with the invention, at this time the grab is moved out of its previous position via the first cam disk out of the recess in the transport drum and is rotated and/or tilted due to the shape of the first guide grooves such that the leading edge of the printed sheet is conveyed in straight line out of the nip along a predetermined path.

After a predetermined path the sheet can for instance in a simple manner be transferred and conveyed further by a downstream transport device such as for instance a chain grab system or a suction belt system. At the time of transfer, and in particular as soon as the sheet has been gripped by the downstream transport device, in accordance with the invention the gripping elements are opened using an appropriate design of the second cam disk and the grab is removed from the transport path by appropriate design of the first cam disk and is moved back into the recess of the cylindrical transport drum.

In accordance with the invention the guide grooves and/or the cam disks are designed such that, at least within the region of the straight-line travel of the sheet, the latter has a speed equal to the circumferential speed of the transport drum so that conditions are always the same while the sheet is being printed, in particular while the leading portion of the sheet is being printed.

Naturally it is also possible to integrate a plurality of grabs of this type in one transport drum, depending on the design of a printer, the cam disks in this case being adapted appropriately.

Given a correspondingly more or less symmetrical design of the movement directions of the grab, it is furthermore possible at any time to transport the sheets to be printed in a straight line through the nip of a printer or coater. In this case in order to grip the leading edge of a sheet delivered by an upstream transport device the grab is moved far enough out of its recess and the grabs are opened so that the leading edge of the sheet strikes the stops in the grabs and then the grabs are closed with the sheet aligned and fixed in the transport direction.

On further rotation of the transport drum in the working direction, within a predetermined angular movement, the grab then sinks into the recess in the transport drum, the grab simultaneously rotating and/or tilting via its first guide grooves such that the support and thus the leading edge of the conveyed sheet are always aligned in a straight line and run in a straight line. In the nip itself the grab can be completely recessed in the recess such that a print roller can roll over the recess with no problem. Immediately after printing has occurred the grab is again moved out of the recess using an appropriate design of the first guide grooves and the first cam disk such that the leading edge of the printed sheet runs tangential to the nip and the sheet is guided overall in a straight line through the printer. The release of the leading edge of the sheet and its transfer to a downstream transport system can then occur as described above.

In accordance with the invention the guide grooves and/or the cam disks are formed such that at least within the zone of the straight-line travel of the sheet the latter has a speed equal to the circumferential speed of the transport drum so that conditions are always the same while the sheet is being printed, in particular while the leading portion of the sheet is being printed.

The figures in the following show illustrated embodiments of the invention.

FIG. 1 shows a first embodiment of a cylindrical transport drum according to the invention having a movable grab;

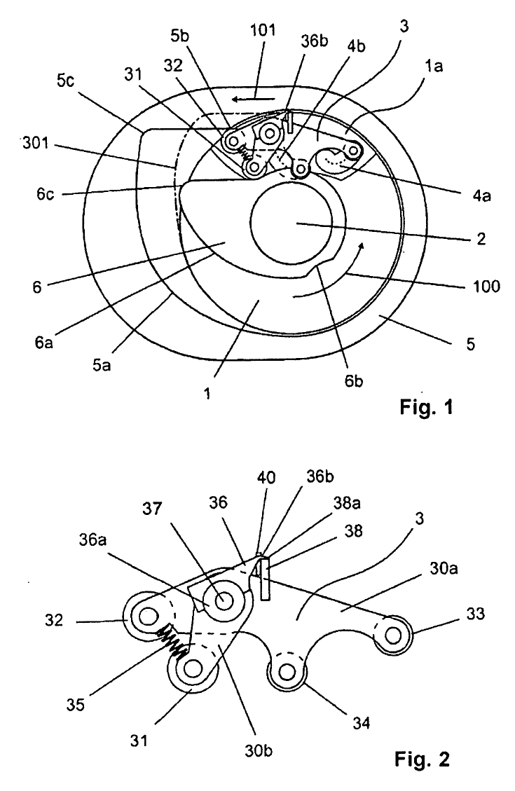

FIG. 2 is a side elevation of the movable grab in accordance with FIG. 1;

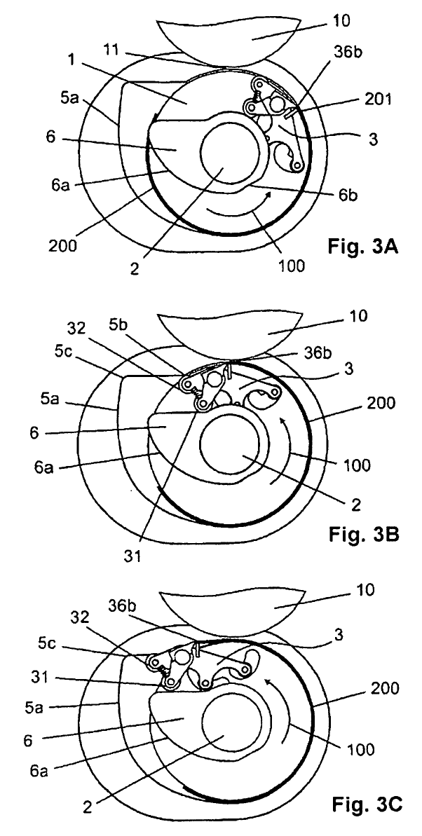

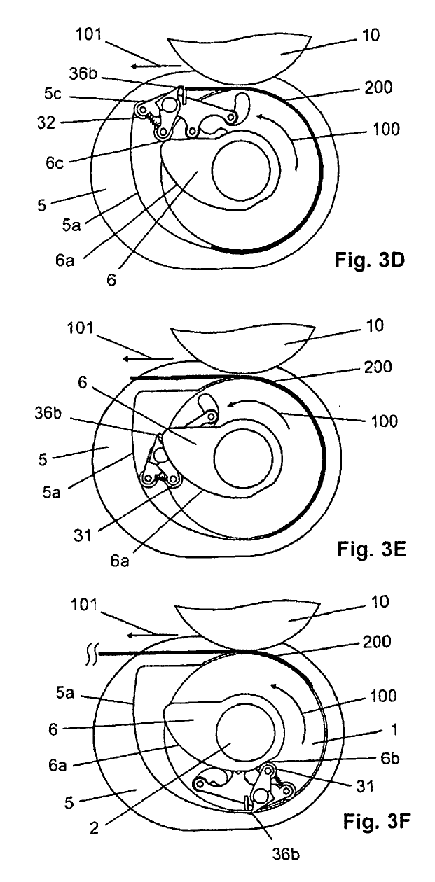

FIGS. 3A to 3F show a first embodiment of a transport drum according to the invention in accordance with FIG. 1 in different angular positions;

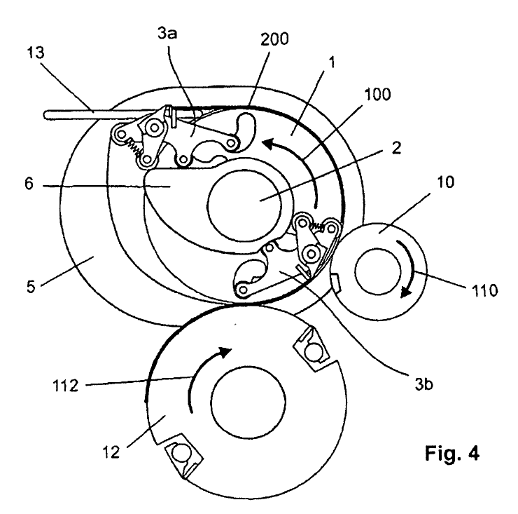

FIG. 4 shows an arrangement of a transport drum having two grabs in one printer;

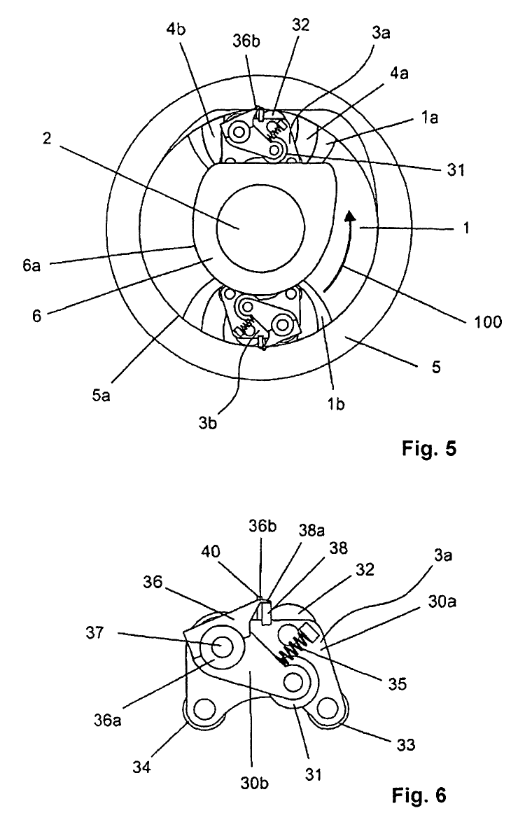

FIG. 5 shows a second embodiment of a transport drum according to the invention having a movable grab;

FIG. 6 is a side elevation of the movable grab in accordance with FIG. 5;

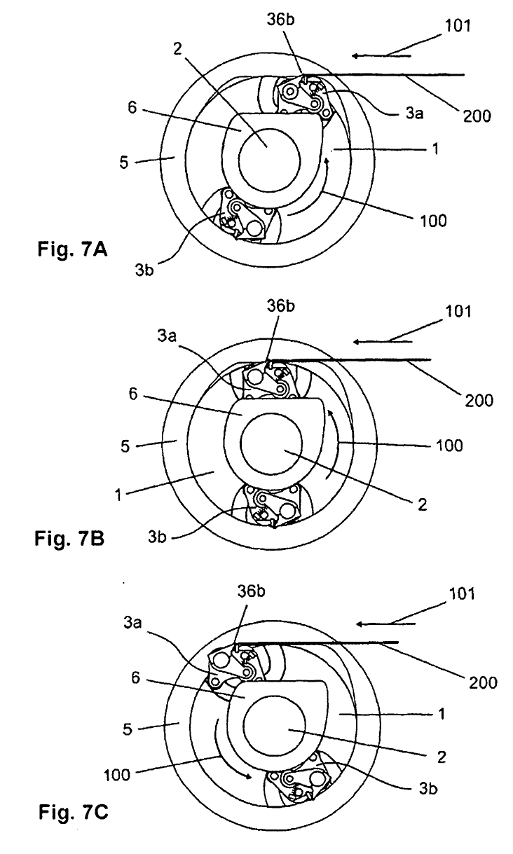

FIGS. 7A through 7C show a second embodiment of a transport drum according to the invention in accordance with FIG. 5 at different angular positions.

FIGS. 1 and 2 respective show a first embodiment according to the invention of a transport drum having a grab 3 movable in a recess 1a and a detailed end view of the grab 3. The cylindrical transport drum 1 rotatable about its axis 2 in a printer and has the recess 1a in which the grab 3 is movable.

The grab 3 has end plates 30a that e.g. are connected to one another e.g. via a grab shaft 37 and/or a connector 38. A number of gripping elements 36 are fixed on the grab shaft 37 e.g. via mounts 36a such that they are rotatable about the axis of the gripping shaft 37 and can be rotated for instance via a control lever 30b attached to the fastening elements 36a such that the outer end 36b of the gripping element 36 in a first position is supported on the connector 38 and in a second position is raised from it.

Moreover, the gripping elements or the connectors have respective stops 40 for the leading edge of the sheet that is to be held securely so that this leading edge can be securely clamped by the grabs 36 in a defined position between their outer ends 36b and the support pieces 38. It is advantageous to resiliently prestress the fastening elements 36a to compensate for the different forces that occur depending on sheet thickness.

The gripping elements can be controlled for opening and closing the grabs for instance in that each control lever 30b has on its end remote from the grab shaft a respective roller 31 that rolls for instance along a surface 6a of a cam disk 6, another roller 32 attached to the end plate 3 acting as counter-bearing and itself rolling along a surface 5a of another cam disk 5. Depending on the spacing between the rollers 31 and 32, which is determined by the angular position of the transport drum 1 and the design of the surfaces 5a and 6a, this spacing can be reduced or increased so that the gripping elements 36 are either closed or opened. A mechanical prestress for instance from a spring 35 prevents the grabs from moving on uncontrolledly. A spring 35 can press the end of the control lever 30b remote from the shaft with its roller 32 against a portion of the end plate 3.

Moreover, the end plates 30a each have additional rollers 33 and 34 that ride in respective cam recesses or rails 4a and 4b attached to the transport drum 1 and depending on their design and shape make it possible for the grab 3 to rotate and/or tilt about a rotation axis that runs parallel to the cylinder axis 2.

The shape of the surfaces 5a and 6a of the cam disks 5 and 6 furthermore cause the grab 3, when the transport drum 1 rotates about its axis 2 in direction 100 depending on the rotation position of the transport drum 1, either to move out of the recess 1a or to move into it or to remain therein for a predetermined angular movement. To this end for instance the surface 5a has a point portion, and once the roller 32 has rolled over it the grab 3 is moved continuously out of the recess 1a. At the same time the rollers 33 and 34 are moved in the rails 4a and 4b, so that depending on the shape and design the grab 3 can continuously rotate and/or tilt in order for instance to move the leading edge of the sheet clamped between the sheet support 38 and the gripping tip 36b in a straight-line path 101.

After a predetermined angular movement, the roller 32 on the surface 5a reaches a part 5c of the surface 5a or the roller 31 rolling on the surface 6a reaches a part 6c of the surface 6, so that the effective spacing between the rollers 31 and 32 is increased such that the grab 36 opens and thus releases the sheet and at the same time the grab 3 is moved out of the straight-line path 101 largely in the direction 100 and thus the sheet can be moved unimpeded further on the path 101 using a downstream transport device (not shown). Thus the grab tip moves on a path that is shown at broken line 301.

For clarifying the sequence of movements, FIGS. 3A through 3F show the rotation of a cylindrical transport drum in different positions.

FIG. 3A shows a transport drum 1 with a sheet 200 on its surface whose leading edge 201 which is securely clamped by the outer end 36b of the grab 36 of the grab 3. At this point the grab 3 is in the recess 1a of the transport drum below the surface of the cylinder so that it is possible for an impression cylinder 10 to roll over it with no problem.

After the transport drum 1 has rotated about its rotation axis 2 in direction 100, the leading edge 201 of the sheet 200 moves into a nip 11 defined between the transport drum 1 and the impression cylinder 10 so that the sheet 200 can be printed using the impression cylinder 11. At this time the roller 32 travels over the point 5b of the surface 5 so that, further rotation of the transport drum 1 in direction 100, moves the grab 3 continuously out of the recess 1a of the cylindrical transport drum 1. At the same time, the grab 3 is rotated and/or tilted by the rollers 33 and 34 and the followers 4a and 4b that are also moved on the transport drum 1 such that a support surface 38a of the connector 38 always runs parallel to the path 101 and along it, the leading edge 201 of the sheet 200 moving in a plane on the path 101 as FIGS. 3B and 3C show. The outward movement thus is tangential to the transport drum. After further angular movement as shown in FIG. 3D, the roller 32 finally travels into the region 5c of the surface 5 and the roller 31 travels into the region 6c of the surface 6 so that the grab 36 opens and releases the leading edge 201 of the sheet 200.

At the same time, the grab 3 is pivoted out of the sheet travel path 101 by rotation of the transport drum 1 in direction 100 so that the sheet 200 can be conveyed away on the path 101 with no problem by a downstream transport device, as shown in FIG. 3E. For continuous operation, when the transport drum 1 is at a predetermined angular position, as shown in FIG. 3F, it can be advantageous to raise the grab 3 as described above, using an appropriate shape of the surfaces 5 and 6, above the surface of the transport drum 1 and to open the grabs for instance using an appropriate shape of the surface 6 at a location 6b such that a following sheet is set against the stops 40 and can be gripped by the grabs.

FIG. 4 shows another arrangement of an inventive cylindrical transport drum 1 having two grabs 3a and 3b in a printer. In this case, for instance the sheets 200 to be processed are transferred from an upstream transport drum 12 to the inventive transport drum 1 at their point of contact, the rotation directions 100 and 112 of the two cylinders at the transfer point having the same direction and being synchronized such that the transfer can occur with positional accuracy and with no problems.

Immediately after a sheet to be processed has been transferred, one or a plurality of impression cylinders 10 provided at the transport drum 1 can print or coat the sheet on the transport drum. The rotation direction 110 and the speed of the impression cylinder is matched to the rotation direction and speed of the transport drum 1 such that the sheet can be printed or coated with positional accuracy and with no problems. In this example the cylindrical transport drum also acts as a counterpressure cylinder. On a side opposite the sheet transfer from the transport drum 12, for instance a transport belt 13 is juxtaposed with the inventive transport drum 1 such that a printed or coated sheet can be drawn far enough onto the transport belt 13 by the movable grab 3a and 3b that the sheet can be fixed at least in its leading portion by for instance grabs disposed on the transport belt 13 or a vacuum suction system and securely conveyed farther by the transport belt 13.

FIGS. 5 and 6 respectively show another embodiment according to the invention of a transport drum 1 having two grabs 3a and 3b that are each movable in a respective recess and an end-face detail view of one of the grabs 3a and 3b.

The grabs 3a and 3b each have end plates 30a that are connected to one another via a grab shaft 37. Several gripping elements 36 are attached to the grab shaft 37 via fastening elements 36a such that they can each be rotated about the axis of the respective grab shaft 37 and can be rotated for instance via a control lever 30b attached to the fastening elements 36a such that in a first position the outer end 36b of the gripping element 36 is positioned against a support piece 38 and in a second position is raised therefrom. Moreover, the gripping elements have appropriate stops 40 for the leading edge of the sheet to be held securely so that they can be clamped in a defined position by the grabs 36 between their leading edges 36b and the support pieces 38. It can be advantageous to resiliently prestress each of the fastening elements 36a to compensate the different forces that occur depending on sheet thickness.

Similar to what was described above, each grab 3a and 3b furthermore has rollers 33 and 34 that run in respective cam recesses or rails 4a, 4b attached to the transport drum 1 and depending on their design and shape make it possible for the grab 3 to rotate and/or tilt about a rotation axis that runs parallel to the cylinder axis 2.

The cam recesses 4a and 4b are furthermore made such that grab 3a and 3b can be moved out of their recesses 1a and 1b such that within a predetermined angular movement each connector 38 travels a path that is tangential to the surface of the cylindrical transport drum, the path being centered on the cylinder axis. In accordance with the invention the shape and design of the cam recesses 4a and 4b is such that a rotation and/or tilting of the grab can occur simultaneously, so that it is possible to guide the support surface 38a of the connector 38 within the tangential path parallel thereto so that a sheet leading edge that is held between connector 38 and grab outer end 36b does not buckle.

This makes it possible to grip the leading edge of a sheet for instance from an upstream transport belt by the grab, transport it through a printing machine arranged on the transport drum and print it there, and transfer the sheet thus printed for instance to a downstream transport belt, the sheet being guided at all times. Moreover, each grab 3a and 3b has rollers 31, 32 that roll for instance along the surfaces 5a and 6a of the fixed cam disks 5 and 6 as described above. Depending on the shape and design of the cam surfaces 5a and 6a of the cam disks 5 and 6, it is thus possible to move the grabs 3a and 3b into or out of their respective recess 1a and 1b at predetermined angular positions for the transport drum 1 such that within a predetermined arcuate portion of the transport drum 1 the support surface 38a of the grab 3a and 3b moves in a straight line.

Because the roller 31 always rolls on the running surface 5a of the cam disk 5 and the roller 32 always rolls on the running surface 6a of the cam disk 6, the spacing between the rollers 31 and 32 is a function of the angular position can be reduced at predetermined positions by the shape of the cam disks such that the gripping elements 36 are opened using the lever 30b in order to grip or release for instance the leading edge of a sheet 200.

FIGS. 7A through 7C are schematic representations of three different positions of an inventive second embodiment of a transport drum. In a first position of the grab 3a, as shown in FIG. 7A, the grab 3a is moved out of the recess 1a of the transport drum 1 outside the surface of the cylindrical transport drum and appropriately rotated and/or tilted such that the leading edge of a sheet 200 delivered by an upstream transport system (not shown) can be gripped by the grab tip 36b. At this time the grab tip 36b and the grab support 38a are located at the beginning of a movement path that runs in a straight line, in particular tangential to the surface of the transport drum, such that when the transport drum 1 rotates in the direction 100 the sheet 200 moves on a straight-line path 101.

In a second position, as shown in FIG. 7B, the grab 3a can be for instance completely lowered into its associated recess 1a so that for instance the sheet can be printed using a print roller (not shown). In a third position, as shown schematically in FIG. 7C, the grab 3a is again moved far enough out of its associated recess 1a and is appropriately rotated and/or tilted such that the conveyed sheet can be transferred to a downstream transport device (not shown). In accordance with the invention the sheet is continuously moved farther in a straight-line path 101 by the transport drum and in particular the leading edge of the sheet 200 gripped by the gripping elements 36 does not buckle.

With respect to all embodiments it can be found that the technical features cited in connection with one embodiment can be used not only for the specific embodiment but rather also in the other embodiments. All disclosed technical features of this specification shall be considered essential to the invention and can be combined with one another in any manner or used by themselves.

1. A cylindrical transport drum for conveying sheets in a printing or coating machine having at least one gripping assembly for gripping and holding a leading edge of a sheet to be transported and lying in at least one recess of the transport drum and rotating with the cylindrical transport drum about its rotation axis wherein a drive is provided in or on the cylindrical transport drum that moves the grab of the gripping assembly during a predetermined or predeterminable angular travel of the cylindrical transport drum tangentially to an outer surface of the cylindrical transport drum.

2. The cylindrical transport drum according to claim 1 that wherein the tangential movement of each grab and the respective grab support or the gripping assembly is along the sheet-travel direction in the printing machine.

3. The cylindrical transport drum according to claim 1 wherein the gripping assembly has at least one end plate that is provided on an end of the cylindrical transport drum and at least two first followers, in particular rollers, that ride in or on respective first guides, in particular cam surfaces or grooves, that rotate with the cylindrical transport drum, the first guides controlling movement of the gripping assembly relative to the cylindrical transport drum.

4. The cylindrical transport drum according to claim 3 wherein a end plate of the gripping assembly has at least one second guide, in particular a roller, riding in or on a second guide, in particular a first cam disk, not rotating with the cylindrical transport drum, the second guide moving the gripping assembly in the first guides in dependence on the relative angular positions of the cylindrical transport drum and this second guide.

5. The cylindrical transport drum according to claim 3 wherein a two-arm control lever on a end plate of the gripping assembly has one arm forms a grab with a support and another arm having a third follower that rides in or on a guide, in particular a second cam disk, not rotating with the cylindrical transport drum, the third guide moving the grab relative to the grab support in dependence on the relative angular positions of the cylindrical transport drum and this third guide.

6. The cylindrical transport drum according to claim 5 wherein the control lever is braced by a spring, in particular a compression spring, on the end plate.

7. The cylindrical transport drum according to claim 4 wherein a second and a third follower, in particular second and third rollers, engage second and third cam surfaces of the first and second cam disks, the spring element pressing the second follower on the second cam and the third follower on the third cam.

8. The cylindrical transport drum according to claim 1 wherein a gripping assembly has two end plates that are each at an end of the cylindrical transport drum and that are connected together, in particular by a bar what forms the support for all the grabs.

9. The cylindrical transport drum according to claim 5 wherein the control levers pivotal on the end plates are on the same rotation axle.

10. The cylindrical transport drum according to claim 9 wherein the rotation axle is formed by a common shaft that extends between the end plates.

11. The cylindrical transport drum according to claim 9 wherein at least one further grab is provided between the two end plates on the common shaft and that all the grabs are moveable synchronously with respect to the support.

12. The cylindrical transport drum according to claim 1 wherein a stop is provided on one grab or on one support.

13. A method of conveying sheets in a printing or coating machine having at least one gripping assembly for gripping and holding a leading edge of a sheet to be transported and lying in at least one recess of the cylindrical transport drum and rotating with the cylindrical transport drum about its rotation axis wherein the grab and the respective support of the gripping assembly is moved by a drive provided in or on the cylindrical transport drum during a predetermined or predeterminable angular travel of the cylindrical transport drum tangentially to an outer surface of the cylindrical transport drum.

14. The method according to claim 13 wherein the travel path of the grab and the respective support of the gripping assembly on a full revolution of the cylindrical transport drum about its axis during a predetermined portion of the revolution moves in a straight line that is tangential to an outer surface of the cylindrical transport drum in a straight path by combined inward and/or outward movement of the grab and the respective support into or out of the respective recess relative to the cylindrical transport drum and the orbiting of the grab and the respective support about the axis of the cylindrical transport drum.

15. The method according to claim 13 wherein rotation of the cylindrical transport drum moves a leading edge of a gripped sheet with the grabs, in particular from a nip between the cylindrical transport drum and an impression cylinder, tangentially to an outer surface of the cylindrical transport drum, the gripping assembly moving out of the recess and then the gripping assembly releases the sheet and sinks back into the recess.

16. The method according to claim 13 wherein rotation of the cylindrical transport drum moves the gripping assembly out of the recess, grips a leading edge of a sheet, and moves the grabs tangentially to an outer surface of the cylindrical transport drum and moves the gripping assembly back into the recess.

17. The method according to claim 16 wherein further rotation of the cylindrical transport drum moves the gripping assembly further out of the recess, moves the leading edge of the sheet tangentially further tangentially of the outer surface of the cylindrical transport drum and releases it, whereupon the gripping assembly returns back into the recess.

18. The method according to claim 13 wherein movement of the gripping assembly into and/or out of the recess and/or gripping and releasing a sheet are controlled by followers, in particular rollers, on the gripping assembly that on rotation of the cylindrical transport drum ride on nonrotating guides, in particular cam disks.

19. (canceled)
